(19) United States
(12) Patent Application Publication
(10) Pub. No.: US 2012/0188846 A1
(43) Pub. Date: Jul. 26, 2012

(54) METHOD AND APPARATUS FOR PACKAGING SURFACE ACOUSTIC WAVE TRANSPONDER FOR DOWN-HOLE TOOLS

(75) Inventors: Duke LOI, Frisco, TX (US); Timothy J. MUELLER, Plano, TX (US); Kathleen HANAFAN, Sugar Land, TX (US)

(73) Assignee: HM ENERGY, LLC., Sugar Land, TX (US)

(21) Appl. No.: 13/358,886

(22) Filed: Jan. 26, 2012

Related U.S. Application Data
(60) Provisional application No. 61/436,475, filed on Jan. 26, 2011.
(60) Provisional application No. 61/436,918, filed on Jan. 27, 2011.

(51) Int. Cl. E21B 47/14; G01V 1/40

(52) U.S. Cl. 367/81

(57) ABSTRACT

A method and apparatus for packaging a surface acoustic wave transponder for use in down-hole tool oil & gas environments is provided. An exemplary transponder comprises a surface acoustic wave piezoelectric device, wire bonds, an antenna element, an antenna substrate, a header, and protective coating. The exemplary surface acoustic wave piezoelectric device is attached into a header and wire bonded to the connection leads, which are connected to an antenna element, and then sealed by a protective coating. The header is hermetically sealed and withstands high pressure high temperature environment found in oil & gas down-hole environment.

### CROSS-REFERENCE TO RELATED APPLICATIONS

This application claims benefit from U.S. Provisional Application No. 61/436,475, filed Jan. 26, 2011, entitled METHOD AND APPARATUS FOR PACKAGING SURFACE ACOUSTIC WAVE TRANSPONDER FOR DOWN-HOLE TOOLS (Atty. Dkt. No. HMET-30575), and claims benefit from U.S. Provisional Application No. 61/436,918, filed Jan. 27, 2011, entitled METHOD AND APPARATUS FOR PACKAGING SURFACE ACOUSTIC WAVE TRANSPONDER FOR DOWN-HOLE TOOLS (Atty. Dkt. No. HMET-30581), the specifications of which are incorporated herein by reference.

### TECHNICAL FIELD

Embodiments of the invention relate to a method, device and apparatus associated with packaging a surface acoustic wave (SAW) piezoelectric device into a housing capable of withstanding harsh environments. An exemplary surface acoustic wave transponder receives radio frequency waves from an interrogator or transmitter device and then reflects a predetermined identification number and, in some embodiments, other data via encoded radio frequency waves to a receiver.

### BACKGROUND

Oil exploration companies involved in the drilling, completion and production phases of oil and gas well installations use hundreds, if not thousands, of down-hole tools such as tubulars, drill bits, mud motors, power packs, etc. while drilling, exploring and completing oil and gas wells. Some technologies have been utilized in the recent past to help such companies log individual tools into inventory; track usage of individual tools in drilling, completion and production operations; and ultimately record the removal of individual tools from inventory when their usefulness has expired.

There have been systems created for managing inventories of down-hole tools or assets that are used in the drilling, completion, and production phases of oil and gas wells. In some such systems, a passive silicon chip radio frequency identification (RFID) tag is installed on each asset and recorded or logged in inventory. By providing each tool or asset with an RFID tag, the asset can be tracked throughout its useful life. One example of such a system for managing inventories comprising down-hole tools used in drilling, completion and production of oil and gas wells is discussed in U.S. Publication No. 2009/0055293. One drawback of silicon chip RFID devices is their inability to withstand the vibration on high temperatures associated with down-hole environments.

U.S. Pat. No. 7,602,106 discloses a radio frequency identification (RFID) piezoelectric device package comprising a plethora of components including a hermetically sealed device header that contains the piezoelectric device, which is then installed into the bottom of a radome along with an RF antenna, along with an impedance matching network and other elements. A drawback of such a device is the manufacturing complexity and the number of parts required to assemble the requisite piezoelectric RFID device.

As such, what is needed is an improved down-hole asset tagging device package that can withstand the high pressures, high temperatures as well as the acidic and caustic environments that exist in the down-hole portions of oil and gas wells and that is less complex and less expensive to manufacture than previous devices.

### SUMMARY

Many oil & gas down-hole tools, equipment, and smaller tubular assets need to be identifiably tagged and tracked in harsh environments, for example such as in harsh environments associated with oil & gas exploration. Tagging and tracking technologies are also desirable for tagging above ground and down-hole assets, equipment and tools. Exemplary surface acoustic wave (SAW) technology and packaging has a unique durability capability that traditional semiconductor based radio frequency identification (RFID) technologies lack. Unlike semiconductor piezoelectric devices, surface acoustic wave piezoelectric devices require that there be a small amount of gas on the surface of the SAW device to enable surface acoustic wave propagation therein. Embodiments of the present invention describe and illustrate methods and apparatus associated with packaging surface acoustic wave transponders that have strong mechanical strength and are adapted to withstand large pressure and temperature fluctuations, as well as other harsh environment conditions.

### BRIEF DESCRIPTION OF THE DRAWINGS

For a more complete understanding, reference is now made to the following description taken in conjunction with the accompanying Drawings in which:

FIG. 1 illustrates back side view of an exemplary surface acoustic wave transponder apparatus;

FIG. 2 illustrates a side view of an exemplary surface acoustic wave transponder apparatus;

FIG. 3 illustrates an exemplary surface acoustic wave transponder apparatus installed in an asset;

FIG. 4 illustrates a side view of an exemplary surface acoustic wave transponder installed in an asset; and

FIGS. 5A, 5B, 5C and 5D illustrate a surface acoustic wave header and the exemplary components within.

### DETAILED DESCRIPTION

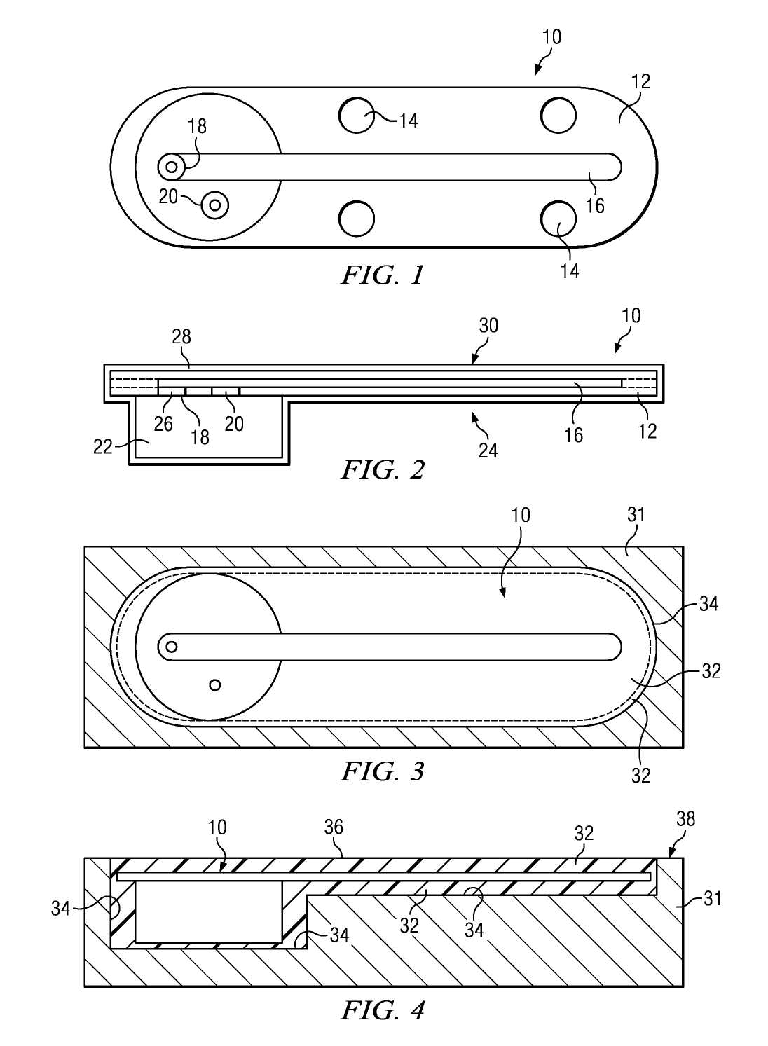

Referring now to the drawings, like or similar elements are designated with identical reference numerals throughout the several views, and the elements depicted are not necessarily drawn to scale. In FIG. 1, a back side view of an exemplary SAW ID device 10 is shown. The SAW ID device 10 comprises an antenna substrate 12, which is shown to be an elongated oval, but other shapes may also be used. The antenna substrate may be made of various materials including circuit board material, fiberglass, resin, non-electrically conductive compounds, plastic or polymer materials. A plurality of through holes 14 may extend through the back surface of the antenna substrate 12 to its front-side surface. An antenna element 16 may be a monopole antenna that is sandwiched within multiple layers of the antenna substrate 12 or embedded within the antenna substrate's material. The antenna element 16 may be a monopole antenna that extends a predetermined length within the antenna substrate 12 of the SAW ID device 10. A first SAW header via 18 extends from the front side of the antenna substrate 12 partially into the front side surface of the antenna substrate proximate to one end or near one end of the antenna element 16. A second SAW header via 20 also extends partially into the front side of the antenna substrate 12 but does not connect electrically to the antenna element 16.

Referring now to FIG. 2, a side view of an exemplary SAW ID device 10 is shown. The antenna substrate 12 is shown to have the antenna element 16 embedded within the antenna substrate material. The antenna element 16 may be sandwiched within multiple layers (e.g., between a top and bottom layer) of the antenna substrate material 12 or may be embedded within an antenna substrate material mold via a manufacturing process. Proximate to a first end of the antenna element 16, a SAW header 22 is attached to the front side 24 of the antenna substrate by means of glue, adhesive, bonding substance, epoxy, prongs, mechanical device, straps, notches, screw threads, or other attachment means known in the art. In some embodiments, a SAW header may have a cylindrical shape and be made of one or more types of durable metals such as steel, stainless steel, iron or various other hardened metal alloys. In other embodiments, the SAW header or outer SAW header shell 22 is made of a non-electrically conductive hardened resin, polymer, acrylic, ceramic or composite material. The SAW header 22 covers the first SAW header via 18 wherein an antenna connection 26 is made between the SAW header 22 and the antenna element 16. The SAW header 22 also covers the second SAW header via 20 and is electrically connected thereto. The second SAW header via 20 is not electrically connected to the antenna element 16. In some embodiments, a coating 28 covers the entire outer surfaces of an exemplary SAW ID device 10. The coating 28 covers the front side 24, the back side 30, the outer surfaces of the SAW header 22 as well as the side surfaces of the antenna substrate 12. The coating 28 may have been applied by being sprayed on or via a dipping process. The coating is adapted to operate as a high temperature protective coating or insulator that slows temperature transfer between an asset or apparatus that an exemplary SAW ID device 10 is installed into and the SAW ID device 10 itself. The coating 28 may further be adapted to operate as a water, fluid or gas resistive seal to aid in keeping caustic, acidic or other damaging chemical fluids or gasses from contacting the antenna substrate 12 or exterior surfaces of the SAW header 22.

FIG. 3 depicts an exemplary SAW ID device 10 installed onto a machined indentation in an asset 31. The asset may be, for example, metal drilling pipe or other pipe, tubing, drilling instrument or asset that may need to be identifiably tagged and tracked in harsh environments, such as oil and gas exploration and down-hole environments. The asset 31 may have an indentation area 34 that has been machined to accept the placement of an exemplary SAW ID device 10. The SAW ID device 10 is placed front side 24 down into the indentation area 34. An epoxy 32 or other sealing substance, which is adapted to withstand the heat and caustic, high pressure, high temperature environment found in oil and gas down-hole environments, is provided in the indentation area 34 of the asset 31 and may cover the front side 24 as well as the backside 30 of an exemplary SAW ID device 10. In SAW ID device embodiments that comprise a plurality of through holes 14 (see FIG. 1), the epoxy 32 flows through and hardens within the through holes 14 thereby increasing the overall strength, durability and monolithic attributes of the epoxy, SAW ID device, asset structure. The epoxy or sealant 32 should have the attribute of being transparent to RF signals when hardened or cured. Once hardened or cured, the epoxy or sealing material 32 may be ground, sanded, polished or contoured to have its top surface coincide with the outer surface of the asset 31.

Referring now to FIG. 4, a side view of an exemplary SAW ID device 10 installed in an asset 31 is shown. The epoxy sealant material 32 fills and, when it is hardened or cured, secures the SAW ID device 10 within the machined indentation area 34 of the asset 31. Additionally, some embodiments taper and/or notch the side walls (not specifically shown) of the indention area 34 to increase the cured epoxy's ability to hold a SAW ID device in place during the tension, compression, twisting, vibration and shock forces that many assets encounter in a down-hole environment. The top surface 36 of the epoxy sealant can be polished, ground or contoured to coexist or mimic the outer surface 38 of the asset 31.

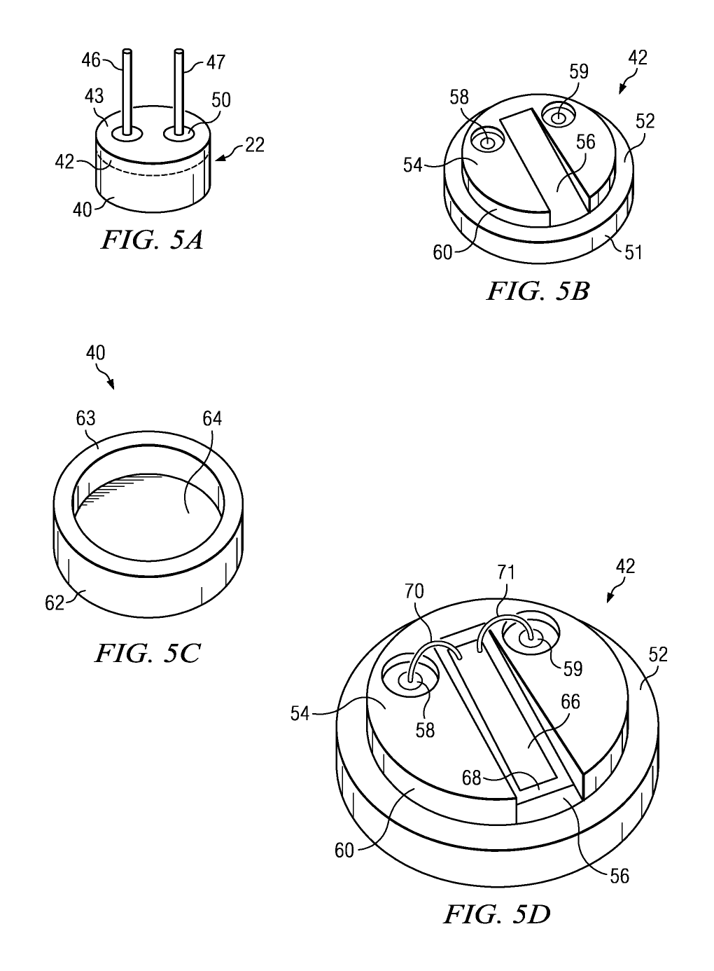

FIGS. 5A, 5B, 5C and 5D will now be discussed. Referring first to 5A, an exemplary SAW header 22 is shown. The SAW header is comprised of a SAW header cover 40 and a SAW header base 42. Extending out of a SAW header base 42 are two SAW header leads 46, 47. Each SAW header lead 46, 47 is surrounded by a dielectric insulating material 50. The dielectric insulating material 50 is necessary so that the SAW header leads 46, 47 are not in electrical contact with the SAW header base 42, which is made of a metal material. The bottom 43 of the SAW header base 42 is attached to the front side 24 of the antenna substrate such that one of the SAW header leads (e.g., SAW header lead 46) is electrically connected to the antenna connection 26 and the antenna element 16. The second SAW header lead (e.g., SAW header lead 47) may be electrically connected to the second SAW header via 20 on the front side 24 of the antenna substrate 12.

FIGS. 5B and 5C depict an exemplary SAW header 22 wherein the SAW header cover 40 and the SAW header base 42 are separated prior to assembly. The SAW header base 42 comprises a base portion with an upper lip 52 extending circumferentially about an upper surface of the header base 42. A raised plateau portion 54 extends upward from the upper lip 52 to define the SAW substrate groove 56. Two dielectric insulated through leads 58, 59 are seen extending from the top surface of the raised plateau 54 through to the bottom surface (not specifically shown) of the SAW header base 42.

About the periphery of the raised plateau 54 and extending downward from the top of the raised plateau 54 to the top of the upper lip 52 is a raised plateau edge 60, which defines the outer periphery of the raised plateau portion 54.

The header cover 40 comprises a lower lip 62 about its bottom surface and a cupped hollow interior 64 is created such that when the header cover 40 is positioned to cover the raised plateau 54 of the header base 42, the raised plateau portion 54 substantially fills the cupped hollow interior 64 of the header cover 40. Furthermore, when the header cover 40 is positioned to cover the raised plateau 54, the lower lip 62 and inner side surface 63 of the header cover 40 engage the upper lip 52 and raised plateau edge 60 of the header base 42 in a compressed fashion thereby establishing a hermetic seal between the header base 42 and header cover 40. The hermetic seal between the header base 42 and the header cover 40 seals the interior portion of the SAW header 22 from contamination by elements outside the SAW header 22.

Referring to FIG. 5D, the header base 42 is shown with a SAW device 66 installed in the SAW substrate groove 56. A bonding agent 68 is used to bond the SAW device 66 onto the SAW substrate groove 56. Wire bonds 70 and 71 electrically connect the SAW device 66 to the conductive through lead within the dielectric insulated through leads 58 and 59.

Some additional advantages and features of embodiments of the invention are that exemplary SAW ID device thicknesses, from a top surface of the SAW header cover to the bottom surface of the antenna substrate can range between about 0.30 to about 0.40 of an inch and be installed in an asset within a machined indention having a maximum depth of less than from about 0.29 to about 0.5 inches, a width of about 0.8 inches and a length ranging from about 1.4 to about 1.5 inches long. An exemplary device has a SAW read performance wherein the signal loss is estimated to be with in the range of only about 0.5 to about 1 dB. Furthermore, the overall number of components associated with an exemplary device is lower than competing devices thereby also reducing the number of manufacturing steps required to assemble an exemplary device, which can effect and lower the overall production costs of an exemplary device. Embodiments further provide a simplified design, while retaining the overall physical strength and durability of the device.

In addition, various embodiments of the invention transmit and receive RF signals in the frequency range of about 2.45 GHz ISM Band +/− about 50 MHz, while providing a read distance of up to about 2 feet when using a 10 dBm SAW reader (greater read distances are possible with higher dBm SAW reader configurations. Since an exemplary device may be used in very deep oil and gas exploration locations, embodiments can be designed and assembled to withstand and operate in a negative hydrostatic pressure situation as well as under up to about 20,000 PSI of hydrostatic pressure (1,379 BAR) while being highly resistant to damage when subjected to sea water, hydrogen sulfide, carbon dioxide, nitrogen, bromine, chloride, and chemicals commonly found in drilling fluids (i.e., mud) used in the oil and gas industry. Exemplary embodiments are attached to or embedded into a down hole asset, such as a drill head, mud motor, battery pack or common tubular components, all of which will encounter vibration, shock, tension and compression forces during each trip in and out of a hole. Thus, exemplary embodiments are designed to remain operational and maximize their time to failure (TTF) by being tested to withstand a 30 g, sine sweep vibration from 5 to 1,000 Hz as well as a shock of 100 g in a 1 ms half sine. Additionally, since exemplary embodiments may be installed in assets that my be spun by various types of machinery during use and storage, exemplary embodiments of the invention are tested to remain operational after being spun and subjected to angular velocities associated with an asset spinning at up to about 120 RPM.

Thus, an exemplary SAW ID device 10 may comprise a header base 42 having a SAW device 66 installed thereon via a bonding agent 68. The SAW device 66 may be connected, via wire bonds 70 and 71 to the conductive part of the dielectric insulated through leads 58 and 59, respectively. Note that the dielectric insulated through leads, in some embodiments, become the SAW header leads 46, 47. An exemplary header cover 40 may be compressively attached to the header base 42 such that the raised plateau is positioned inside a cupped hollow interior 64 of the header cover 40. The raised plateau edge 60 will be compressively engaged with the inner side surface 63 of the header cover such that the lower lip 62 and upper lip 52 are also engaged. The combination of the raised plateau edge being compressively fit into the cupped hollow interior 64 until the upper lip 52 and lower lip 62 are engaged establishes a hermetic seal between the header cover 40 and header base 42. The SAW device 66 is contained within the hermetically sealed SAW header along with a small amount of a predetermined gas contained, at least, within an area above the SAW device 66 and below the inner surface of the cupped hollow interior 64. One of the SAW header leads 46 is electrically connected to the antenna connection 26 through the first SAW header via 18. The second SAW header lead 47 is electrically connected to the second SAW header connection by way of the second SAW header via 20. In some embodiments, the second SAW header connection is a solder point or location about the second via 20; while in other embodiments the second solder header connection is to a second antenna (not specifically shown). In some embodiments, the SAW header 22 is also mechanically or chemically bonded or attached to the front side 24 of the antenna substrate 12. Finally, a protective coating 28 is applied to the entire outer surface of an exemplary SAW ID device 10. The coating 28 is a high temperature tolerant protective coating that slows heat transfer between an asset and an exemplary SAW ID device and further provides additional water, fluid, chemical and gas resistance and protection for the outer surfaces of an exemplary SAW ID device 10.

It will be appreciated by those skilled in the art having the benefit of this disclosure that this method and apparatus for packaging a surface acoustic wave transponder for down-hole tools provides a durable SAW transponder that is adapted to continue operating for a long period of time when installed in a down-hole asset and/or encounters the many harsh environmental conditions encountered by down hole assets in the oil & gas or other similarly harsh industry. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A surface acoustic wave (SAW) identification (ID) device comprising:
an antenna substrate having a front side and a back side;
an antenna structure having a length supported by the antenna substrate;
a first via extending through the antenna structure and the antenna substrate;
a second via extending through the antenna substrate; and
a SAW header comprising:
an outer header shell having a bottom side;
first and second conductive leads extending through the bottom side such that the first lead is electrically connected to the antenna structure at the first via and wherein the second lead is connected to the second via; and
a SAW device contained within the outer header shell and connected to the first and second conductive leads.

2. The SAW ID device of claim 1, wherein the bottom side of the SAW header is attached to the front side of the antenna substrate.

3. The SAW ID device of claim 2, wherein the bottom side of the SAW header covers the first via and the second via.

4. The SAW ID device of claim 1, wherein the first and second conductive leads are electrically insulated from the outer shell.

5. The SAW ID device of claim 1, wherein the antenna structure is embedded in the antenna substrate.

6. The SAW ID device of claim 1, further comprising a non-conductive coating covering the outer surfaces of the device.

7. The SAW ID device of claim 1, further comprising a plurality of through holes that extend from the front surface to the back surface of the antenna substrate.

8. The SAW ID device of claim 1, wherein the SAW header outer header shell comprises a SAW header cover and a SAW header base wherein the SAW header cover and the SAW header base are fitted together such that the SAW device is hermetically sealed within the outer header shell.

9. A SAW ID identifiable asset comprising:
an asset outer wall;
an indention area formed in the asset outer wall;
a SAW ID device positioned inside the indention area, the SAW ID device comprising:
an antenna substrate having a front side and a back side;
an antenna structure having a length supported by the antenna substrate;
a first via extending through the antenna structure and the antenna substrate;
a second via extending through the antenna substrate;
a SAW header comprising:
an outer header shell having a bottom side;
first and second conductive leads extending through the bottom side such that the first lead is electrically connected to the antenna structure at the first via and wherein the second lead is connected to the second via; and
a SAW device contained within the outer header shell and connected to the first and second conductive leads; and
a epoxy sealant filling the indention area and being about the SAW ID device.

10. The SAW ID identifiable asset of claim 9, wherein the antenna substrate further comprises a plurality of through holes, and wherein the epoxy sealant further fills the through holes.

11. The SAW ID identifiable asset of claim 9, wherein a top surface of the epoxy sealant coexists with an outer surface of the asset outer wall.

12. A SAW ID device comprising:
a SAW header comprising:
a header cover comprising a cupped hollow interior;
a header base comprising:
a bottom side;
first and second conductive leads extending through the base;
a dielectric insulating material positioned about and between a portion of each of the first and second conductive leads and the base where the first and second conductive leads extend through the base;
an upper lip extending about an upper surface of the header base;
a raised plateau extending upward from the upper lip;
a groove indention in the raised plateau; and
a SAW device bonded to the grooved indention, the SAW device comprising two wire leads electrically connected to the first and second leads respectively;
wherein the header cover and header base are fitted together forming a hermetic seal there between.

13. The SAW ID device of claim 12, wherein the cupped hollow interior is substantially filled with the raised plateau.

14. The SAW ID device of claim 12, wherein a predetermined gas is contained in an area between a surface of the cupped hollow interior and the SAW device.

15. The SAW ID device of claim 12, wherein at least one of the first and second conductive leads is connected to an antenna structure located outside the SAW header.

16. The SAW ID device of claim 12, adapted to operate in temperatures between −55 and 350 degrees C.

17. The SAW ID device of claim 12 wherein the hermetic seal withstands a hydrostatic pressure of up to about 1,379 BAR.

18. The SAW ID device of claim 12, wherein the bottom side of the header base is attached to an antenna substrate comprising an antenna structure

19. The SAW ID device of claim 12, wherein at least one of the first and second conductive leads is connected to an antenna structure.
